(19) United States
(12) Patent Application Publication
(10) Pub. No.: US 2016/0188397 A1
(43) Pub. Date: Jun. 30, 2016

(54) INTEGRITY OF FREQUENTLY USED DE-DUPLICATION OBJECTS

(71) Applicant: HEWLETT-PACKARD DEVELOPMENT COMPANY, L.P., Houston, TX (US)

(72) Inventors: Alastair Slater, Bristol (GB); Simon Pelly, Bristol (GB)

(21) Appl. No.: 14/908,487

(22) PCT Filed: Jul. 29, 2013
(86) PCT No.: PCT/US2013/052590

§ 371 Date: Jan. 28, 2016

(51) Int. Cl. G06F 11/07; G06F 3/06

(52) U.S. Cl. CPC G06F 11/079; G06F 11/0727; G06F 11/0751; G06F 11/0772; G06F 3/0619; G06F 3/0641; G06F 3/0673

(57) ABSTRACT

Disclosed herein are a system, non-transitory computer-readable medium, and method to check the integrity of de-duplication objects. An integrity check of the most frequently referenced or used de-duplication objects is given higher priority.

### BACKGROUND

De-duplication objects may be used to eliminate redundant copies of data. In the de-duplication process, unique units of data may be identified and stored and subsequent units of data may be compared to the stored units.

### BRIEF DESCRIPTION OF THE DRAWINGS

FIG. 1 is a block diagram of an example system in accordance with aspects of the present disclosure.

FIG. 2 is a flow diagram of an example method in accordance with aspects of the present disclosure.

FIG. 3 is a working example in accordance with aspects of the present disclosure.

FIG. 4 is a further working example in accordance with aspects of the present disclosure.

### DETAILED DESCRIPTION

As noted above, the de-duplication process may include identification and storage of unique units of data and comparison thereof to subsequent units of data. If a redundant unit of data is received, the redundant unit of data may be substituted by a de-duplication object comprising a reference or pointer to the unique unit of data discovered earlier. A de-duplication object may be much smaller in size than the units of data. Thus, given that the same unit of data may occur dozens, hundreds, or even thousands of times, de-duplication may greatly reduce the amount of data in a storage device or may greatly reduce the amount of data transferred over a network. Unfortunately, these de-duplication objects may eventually become corrupt and may no longer refer to the correct unit of data. Corrupt de-duplication objects may be caused by disk failures, I/O errors, database corruption, or operational errors. While some techniques for checking the integrity of de-duplication objects exist, these techniques may check the objects randomly without prioritizing the de-duplication objects. In one example, a priority de-duplication object may be defined as a de-duplication object that is used or referenced frequently by a program accessing the data. In the event the system fails during an integrity check, high priority de-duplication objects may be overlooked. Recovery of these de-duplication objects may include a burdensome manual process.

In view of the foregoing, disclosed herein are a system, computer-readable medium, and method for checking the integrity of de-duplication objects. In one example, an integrity check of the most frequently referenced or used de-duplication objects is given higher priority. In a further example, a warning may be generated, if the integrity of a given de-duplication object fails. Thus, rather than verifying the de-duplication objects randomly or sequentially, the integrity check may be carried out intelligently such that the most referenced de-duplication objects are checked first. In the event of a system failure during an integrity check, the likelihood that high priority de-duplication objects were verified is higher. The aspects, features and advantages of the present disclosure will be appreciated when considered with reference to the following description of examples and accompanying figures. The following description does not limit the application; rather, the scope of the disclosure is defined by the appended claims and equivalents.

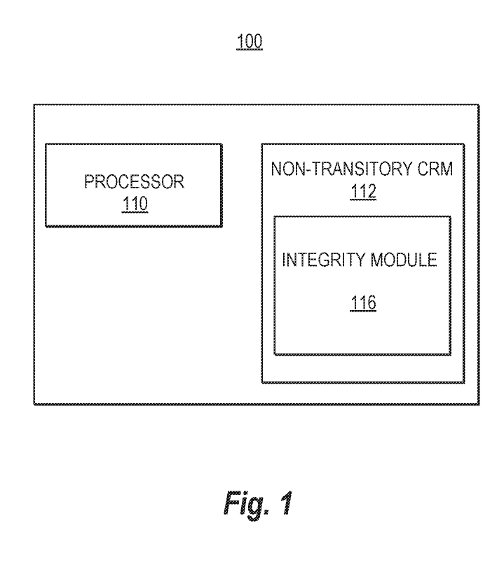

FIG. 1 presents a schematic diagram of an illustrative computer apparatus 100 for executing the techniques disclosed herein. Computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other computers over a network. The computer apparatus 100 may also contain a processor 110, which may be any number of well known processors, such as processors from Intel® Corporation. In another example, processor 110 may be an application specific integrated circuit (“ASIC”). Non-transitory computer readable medium (“CRM”) 112 may store instructions that may be retrieved and executed by processor 110. As will be discussed in more detail below, the instructions may include an integrity module 116. Non-transitory CRM 112 may be used by or in connection with any instruction execution system that can fetch or obtain the logic from non-transitory CRM 112 and execute the instructions contained therein.

Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions residing in non-transitory CRM 112 may comprise any set of instructions to be executed directly (such as machine code) or indirectly (such as scripts) by processor 110. In this regard, the terms “instructions,” “scripts,” and “applications” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

In one example, a storage device may store units of data and may store a de-duplication object in lieu of at least one redundant copy of a given unit of data. As noted above, the de-duplication object may comprise a pointer to the given unit of data. The storage device may be any device that allows information to be retrieved, manipulated, and stored by processor 110. Some examples of storage devices include, but are not limited to, disk drives, fixed or removable magnetic media drives (e.g., hard drives, floppy or zip-based drives), writable or read-only optical media drives (e.g., CD or DVD), tape drives, or solid-state mass storage devices. In a further example, integrity module 116 may instruct at least one processor to determine which de-duplication objects are most frequently referenced and to execute an integrity check of the de-duplication objects, such that the most frequently referenced de-duplication objects are given priority over other de-duplication objects. In a further example, integrity module 116 may generate a warning, if the integrity check of a de-duplication object fails.

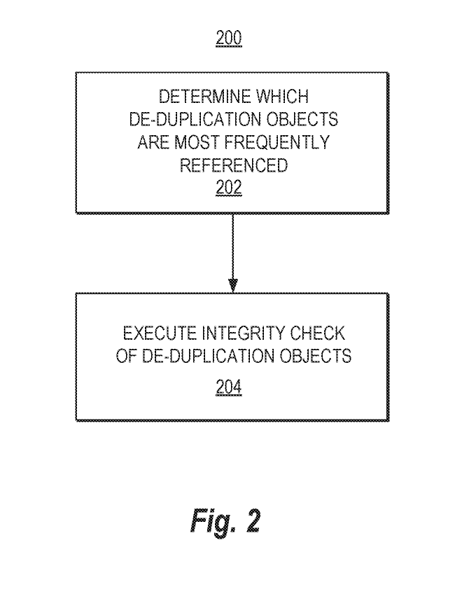

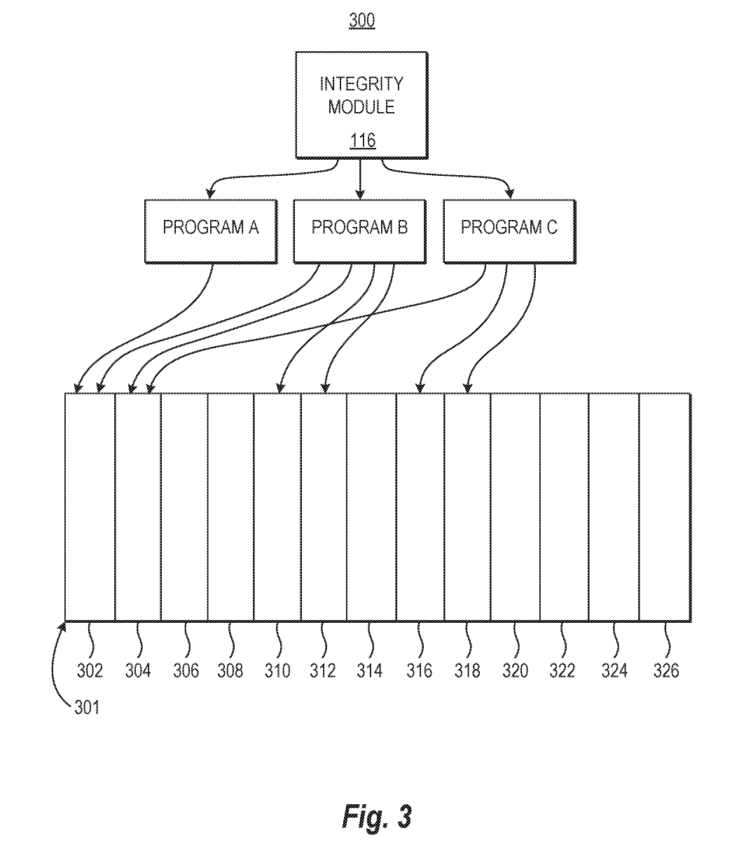

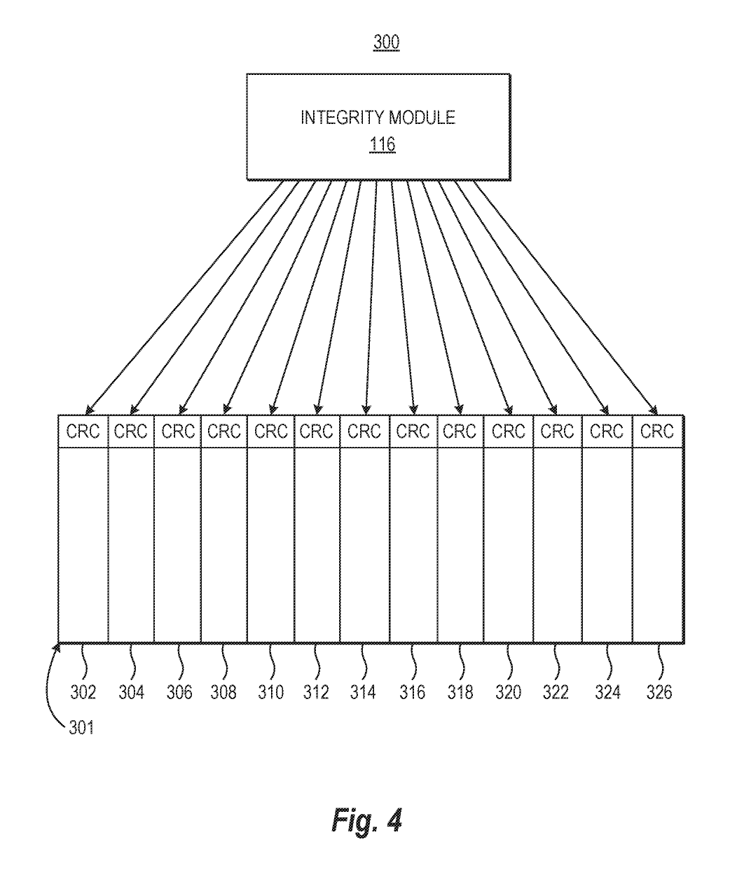

Working examples of the system, method, and non-transitory computer-readable medium are shown in FIGS. 2-4. In particular, FIG. 2 illustrates a flow diagram of an example method 200 for checking the integrity of de-duplication objects. FIGS. 3-4 each show a working example in accordance with the techniques disclosed herein. The actions shown in FIGS. 3-4 will be discussed below with regard to the flow diagram of FIG. 2.

As shown in block 202 of FIG. 2, the most frequently used de-duplication objects may be determined. In one example, a threshold may be used to distinguish between the most frequently used and not most frequently used de-duplication objects. In one example, a de-duplication object used in backup storage and that is referenced more than once a week may be deemed a most frequently used de-duplication object. A backup file that is referenced more than once a week may be considered critical. Referring now to FIG. 3, programs A, B, and C may be programs that write and read data to and from storage device 301. In this example, the storage device 301 may comprise de-duplication objects 302 thru 326. Integrity module 116 may monitor programs A, B, and C to determine which de-duplication objects are most frequently referenced by programs A, B, and C. The monitoring may be carried out using conventional monitoring tools, such as, for example, the system activity report (“SAR”) tool available in a UNIX environment; alternatively, the mode notify (“Inotify”) tool may be utilized.

Referring back to FIG. 2, an integrity check of de-duplication objects may be executed, as shown in block 204. As noted above, the integrity check of the de-duplication objects may be scheduled such that the most frequently referenced de-duplication objects are given higher priority. In one example, the integrity check of each de-duplication object may be carried out using a checksum generated for each de-duplication object. Referring now to FIG. 4, integrity module 116 is shown scanning the de-duplication objects of storage device 301 and checking the integrity of each de-duplication object. In the example, of FIG. 4, the order in which the de-duplication objects are checked may be based on the frequency with which the objects are referenced by programs A, B, and C. FIG. 4 illustratively shows the checksum or cyclic redundancy check (“CRC”) embedded with the de-duplication object in the file system of storage device 301. However, the checksums may be also be stored in computer registers, in a relational database as a table having a plurality of different fields and records, XML documents, or flat files. The checksums may be formatted in any computer-readable format.

In another example, integrity module 116 may also check the integrity of the units of data themselves. In one example, a backup copy of each unit of data may be retained. If integrity module 116 determines that a unit of data is corrupt, integrity module 116 may modify each de-duplication object associated with the corrupt unit of data to point to the backup copy of each unit of data. Thus, integrity module 116 may check the integrity of the de-duplication objects and their associated data units.

Advantageously, the foregoing system, method, and non-transitory computer readable medium may confirm the integrity of de-duplication objects in a prioritized manner and may also redirect the de-duplication objects if their associated data units are corrupt. In this regard, rather than checking the de-duplication objects randomly or sequentially, the de-duplication objects may be verified in a more intelligent manner. In turn, users of programs that access the data via the de-duplication objects can be rest assured that the most important data is stable.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising:
a storage device to store units of data and to store a de-duplication object in lieu of at least one redundant copy of a given unit of data, the de-duplication object comprising a pointer to the given unit of data;
an integrity module which, if executed, instructs at least one processor to:
determine which de-duplication objects are most frequently referenced;
execute an integrity check of the de-duplication objects such that the most frequently referenced de-duplication objects are given priority over other de-duplication objects; and
generate a warning, if the integrity check of a given de-duplication object fails.

2. The system of claim 1, wherein the integrity module, if executed, further instructs at least one processor to:
generate a checksum for each de-duplication object; and
check the integrity of each de-duplication object using the checksum thereof.

3. The system of claim 2, wherein the integrity module, if executed, further instructs at least one processor to embed the checksum with the de-duplication object associated therewith in a file system of the storage device.

4. The system of claim 2, wherein the integrity module, if executed, further instructs the processor to store the checksum generated for each de-duplication object in a database.

5. The system of claim 1, wherein the integrity module, if executed, further instructs the processor to:
retain a backup copy of a unit of data in the storage device;
determine whether the unit of data is corrupt; and
if the unit of data is corrupt, modify each de-duplication object associated with the corrupt unit of data to point to the backup copy.

6. A non-transitory computer readable medium having instructions therein which, if executed, cause a processor to:
scan de-duplication objects in a storage device, each de-duplication object comprising a reference to a unit of data in the storage device such that each de-duplication object substitutes for redundant copies of the unit of data;
determine which de-duplication objects are most frequently referenced by programs accessing the storage device;
schedule an integrity check of the de-duplication objects such that the most frequently referenced de-duplication objects are given higher priority; and
generate a warning, if the integrity check of a given de-duplication object fails.

7. The non-transitory computer readable medium of claim 6, wherein the instructions therein, if executed, further instruct at least one processor to:
generate a checksum for each de-duplication object; and
check the integrity of each de-duplication object using the checksum thereof.

8. The non-transitory computer readable medium of claim 7, wherein the instructions therein, if executed, further instruct at least one processor to embed the checksum with the de-duplication object associated therewith in a file system of the storage device.

9. The non-transitory computer readable medium of claim 7, wherein the instructions therein, if executed, further instruct at least one processor to store the checksum generated for each de-duplication object in a database.

10. The non-transitory computer readable medium of claim 7, wherein the instructions therein, if executed, further instruct at least one processor to
retain a backup copy of the unit of data in the storage device;
determine whether the unit of data is corrupt; and
if the unit of data is corrupt, modify each de-duplication object associated with the corrupt unit of data to point to the backup copy.

11. A method comprising
monitoring, using at least one processor, de-duplication objects in a storage device, each de-duplication object comprising a reference to a unit of data in the storage device such that each de-duplication object substitutes for redundant copies of the unit of data;
determining, using at least one processor, which de-duplication objects are most frequently used by programs accessing data in the storage device;
executing, using at least one processor, an integrity check of the de-duplication objects such that the most frequently used de-duplication objects are given higher priority over other de-duplication objects; and
generating, using at least one processor, a warning, if the integrity check of a given de-duplication object fails.

12. The method of claim 11, further comprising:
generating, using at least one processor, a checksum for each de-duplication object; and
checking, using at least one processor, the integrity of each de-duplication object using the checksum thereof.

13. The method of claim 12, further comprising embedding, using at least one processor, the checksum with the de-duplication object associated therewith in a file system of the storage device.

14. The method of claim 12, further comprising storing, using at least one processor, the checksum generated for each de-duplication object in a database.

15. The method of claim 11, further comprising:
retain a backup copy of the unit of data in the storage device;
determine whether the unit of data is corrupt; and
if the unit of data is corrupt, modify each de-duplication object associated with the corrupt unit of data to point to the backup copy.
